(19) United States
(12) Patent Application Publication
(10) Pub. No.: US 2018/0027494 A1
(43) Pub. Date: Jan. 25, 2018

(54) APPARATUS, SYSTEM AND METHOD OF NEIGHBOR AWARENESS NETWORKING (NAN) DATA LINK (NDL) POWER SAVE

(71) Applicant: INTEL IP CORPORATION, Santa Clara, CA (US)

(72) Inventors: Po-Kai Huang, San Jose, CA (US); Emily H. Qi, Gig Harbor, WA (US); Elad Oren, Tel Aviv (IL)

(21) Appl. No.: 15/391,317

(22) Filed: Dec. 27, 2016

Related U.S. Application Data
(60) Provisional application No. 62/366,187, filed on Jul. 25, 2016.

(51) Int. Cl. H04W 52/02; H04W 52/38; H04W 72/04; H04W 68/00; H04W 76/02

(52) U.S. Cl. CPC H04W 52/0235; H04W 68/00; H04W 76/02; H04W 72/0446; H04W 52/383; H04W 72/0473; H04W 84/12

(57) ABSTRACT

Some demonstrative embodiments include apparatuses, systems and/or methods of Neighbor Awareness Networking (NAN) Data Link (NDL) power save. For example, an apparatus may include logic and circuitry configured to cause a first NAN device to set up an NDL with a second NAN device; to communicate a power save request between the first and second NAN devices during a Common Resource Block (CRB) of the NDL; to communicate a power save response between the first and second NAN devices, the power save response in response to the power save request; and to enter a power save state for at least part of the CRB.

### CROSS REFERENCE

This application claims the benefit of and priority from U.S. Provisional Patent Application No. 62/366,187 entitled “APPARATUS, SYSTEM AND METHOD OF NAN DATA LINK (NDL) POWER SAVE SIGNALING”, filed Jul. 25, 2016, the entire disclosure of which is incorporated herein by reference.

### TECHNICAL FIELD

Embodiments described herein generally relate to Neighbor Awareness Networking (NAN) Data Link (NDL) Power Save.

### BACKGROUND

Awareness networking, for example, according to a Wi-Fi Aware Specification, may enable wireless devices, for example, Wi-Fi devices, to perform device/service discovery, e.g., in their close proximity.

The awareness networking may include forming a cluster, e.g., a Wi-Fi Aware cluster, for devices in proximity. Devices in the same Wi-Fi Aware cluster may be configured to follow the same time schedule, e.g., a discovery window (DW), for example, to facilitate cluster formation and/or to achieve low power operation.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic illustration of a Paging Neighbor Awareness Networking (NAN) Data Link (NDL) (P-NDL) scheme, which may be implemented in accordance with some demonstrative embodiments.

FIG. 3 is a schematic illustration of scheduling a power save period during a Common Resource Block (CRB), in accordance with some demonstrative embodiments.

FIG. 4 is a schematic illustration of a sequence diagram of operations and communications between a first NAN device and a second NAN device, in accordance with some demonstrative embodiments.

FIG. 5 is a schematic illustration of scheduling a power save period during a CRB of a synchronized NDL (S-NDL) scheme, in accordance with some demonstrative embodiments.

FIG. 6 is a schematic flow-chart illustration of a method of NDL power save, in accordance with some demonstrative embodiments.

FIG. 7 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc, indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc, to describe a common object, merely indicate that different instances of like objects are being referred to, and are not intended to imply that the objects so described must be in a given sequence, either temporally, spatially, in ranking, or in any other manner.

Some embodiments may be used in conjunction with devices and/or networks operating in accordance with existing (WiFi) Alliance (WFA) Specifications (including Wi-Fi Neighbor Awareness Networking (NAN) Technical Specification, Version 1.0, May 1, 2015) and/or future versions and/or derivatives thereof, devices and/or networks operating in accordance with existing WFA Peer-to-Peer (P2P) specifications (WiFi P2P technical specification, version 1.5, Aug. 4, 2014) and/or future versions and/or derivatives thereof, devices and/or networks operating in accordance with existing IEEE 802.11 standards (including IEEE 802.11-2012 (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012); IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28 Dec. 2012); IEEE-802.11REVmc (“IEEE 802.11-REVmc™/D6.0, June 2016, draft standard for Information technology—Telecommunications and information exchange between systems Local and metropolitan area networks Specific requirements; Part 11: Wireless LAN Medium Access Control (MAC) and Physical Layer (PHY) Specification”); IEEE 802.11ax (IEEE 802.11ax, High Efficiency WLAN (HEW)); IEEE 802.11ay (P802.11ay Standard for Information Technology—Telecommunications and Information Exchange Between Systems Local and Metropolitan Area Networks—Specific Requirements Part 11: Wireless LAN Medium Access Control (MAC) and Physical Layer (PHY) Specifications—Amendment: Enhanced Throughput for Operation in License-Exempt Bands Above 45 GHz)) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a WiFi network. Other embodiments may be used in conjunction with any other suitable wireless communication network, for example, a wireless area network, a “piconet”, a WPAN, a WVAN and the like.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “peer to peer (PTP) communication”, as used herein, may relate to device-to-device communication over a wireless link (“peer-to-peer link”) between devices. The PTP communication may include, for example, a WiFi Direct (WFD) communication, e.g., a WFD Peer to Peer (P2P) communication, wireless communication over a direct link within a QoS basic service set (BSS), a tunneled direct-link setup (TDLS) link, a STA-to-STA communication in an independent basic service set (IBSS), or the like.

Some demonstrative embodiments are described herein with respect to WiFi communication. However, other embodiments may be implemented with respect to any other communication scheme, network, standard and/or protocol.

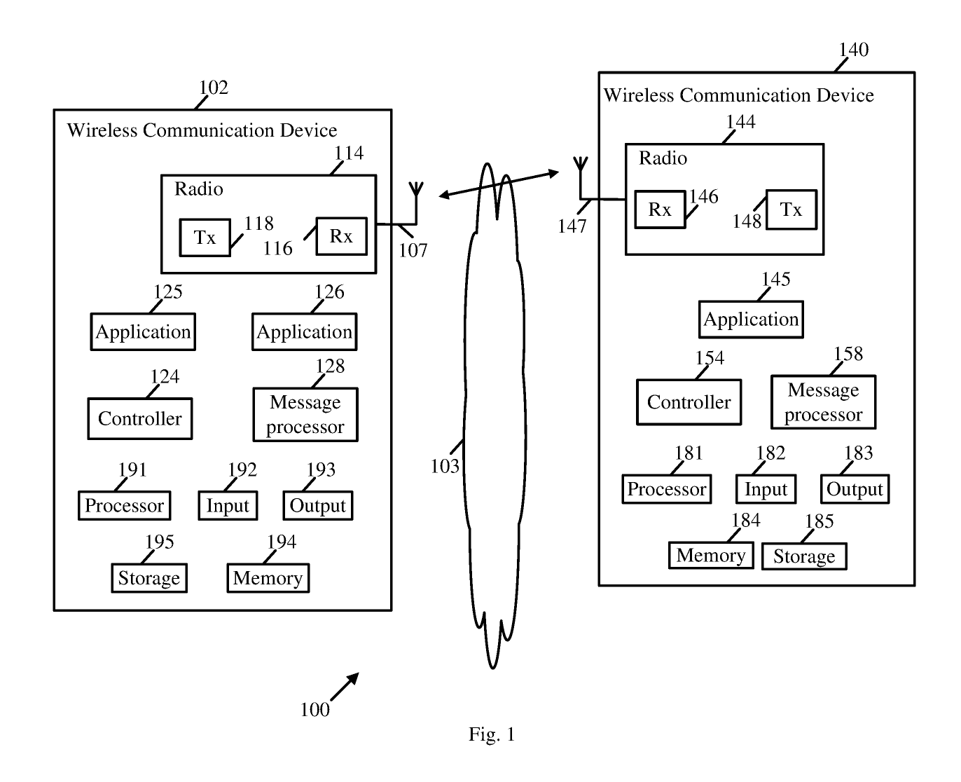

Reference is now made to FIG. 1, which schematically illustrates a block diagram of a system 100, in accordance with some demonstrative embodiments.

As shown in FIG. 1, in some demonstrative embodiments system 100 may include a wireless communication network including one or more wireless communication devices, e.g., wireless communication devices 102 and/or 140.

In some demonstrative embodiments, wireless communication devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, a handheld device, an Internet of Things (IoT) device, a sensor device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, devices 102 and/or 140 may include, operate as, and/or perform the functionality of one or more STAs. For example, device 102 may include at least one STA, and/or device 140 may include at least one STA.

In some demonstrative embodiments, devices 102 and/or 140 may include, operate as, and/or perform the functionality of one or more WLAN STAs.

In some demonstrative embodiments, devices 102 and/or 140 may include, operate as, and/or perform the functionality of one or more Wi-Fi STAs.

In some demonstrative embodiments, devices 102 and/or 140 may include, operate as, and/or perform the functionality of one or more BT devices.

In some demonstrative embodiments, devices 102 and/or 140 may include, operate as, and/or perform the functionality of one or more Neighbor Awareness Networking (NAN) STAs.

In some demonstrative embodiments, devices 102 and/or 140 may include, operate as, and/or perform the functionality of one or more location measurement STAs.

In one example, a station (STA) may include a logical entity that is a singly addressable instance of a medium access control (MAC) and physical layer (PHY) interface to the wireless medium (WM). The STA may perform any other additional or alternative functionality.

In some demonstrative embodiments, devices 102 and/or 140 may include, operate as, and/or perform the functionality of any other devices and/or STAs.

In some demonstrative embodiments, devices 102 and/or 140 may be configured to operate as, and/or to perform the functionality of, an access point (AP) STA.

In some demonstrative embodiments, devices 102 and/or 140 may be configured to operate as, and/or to perform the functionality of, a non-AP STA.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In one example, device 102 may be configured to operate as, and/or to perform the functionality of an AP STA, and/or device 140 may be configured to operate as, and/or to perform the functionality of a non-AP STA.

In some demonstrative embodiments, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative embodiments, some or all of the components of one or more of devices 102 and/or 140 may be enclosed in a common housing or packaging, and may be interconnected or operably associated using one or more wired or wireless links. In other embodiments, components of one or more of devices 102 and/or 140 may be distributed among multiple or separate devices.

In some demonstrative embodiments, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative embodiments, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, wireless communication devices 102 and/or 140 may be capable of communicating content, data, information and/or signals via a wireless medium (WM) 103. In some demonstrative embodiments, wireless medium 103 may include, for example, a radio channel, a cellular channel, a Global Navigation Satellite System (GNSS) Channel, an RF channel, a WiFi channel, an IR channel, a Bluetooth (BT) channel, and the like.

In some demonstrative embodiments, wireless communication medium 103 may include a wireless communication channel over a 2.4 Gigahertz (GHz) frequency band, a 5 GHz frequency band, a millimeterWave (mmWave) frequency band, e.g., a 60 GHz frequency band, a Sub 1 Gigahertz (S1G) band, and/or any other frequency band.

In some demonstrative embodiments, devices 102 and/or 140 may include one or more radios including circuitry and/or logic to perform wireless communication between devices 102, 140 and/or one or more other wireless communication devices. For example, device 102 may include at least one radio 114, and/or device 140 may include at least one radio 144.

In some demonstrative embodiments, radio 114 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative embodiments, radios 114 and/or 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative embodiments, radios 114 and/or 144 may be configured to communicate over a 2.4 GHz band, a 5 GHz band, an mmWave band, a S1G band, and/or any other band.

In some demonstrative embodiments, radios 114 and/or 144 may include, or may be associated with, one or more antennas 107 and/or 147, respectively.

In one example, device 102 may include a single antenna 107. In another example, device 102 may include two or more antennas 107.

In one example, device 140 may include a single antenna 147. In another example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, wireless communication devices 102 and/or 140 may form, and/or may communicate as part of, a wireless local area network (WLAN).

In some demonstrative embodiments, wireless communication devices 102 and/or 140 may form, and/or may communicate as part of, a WiFi network.

In some demonstrative embodiments, wireless communication devices 102 and/or 140 may form, and/or may communicate as part of, a WiFi Direct (WFD) network, e.g., a WiFi direct services (WFDS) network, and/or may perform the functionality of one or more WFD devices.

In one example, wireless communication devices 102 and/or 140 may include, or may perform the functionality of a WiFi Direct device.

In some demonstrative embodiments, wireless communication devices 102 and/or 140 may be capable of performing awareness networking communications, for example, according to an awareness protocol, e.g., a WiFi aware protocol, and/or any other protocol, e.g., as described below.

In some demonstrative embodiments, wireless communication devices 102 and/or 140 may be capable of forming, and/or communicating as part of, a Neighbor Awareness Networking (NAN) network, e.g., a WiFi NAN or WiFi Aware network, and/or may perform the functionality of one or more NAN devices (“WiFi aware devices”).

In some demonstrative embodiments, wireless communication medium 103 may include a direct link, for example, a PTP link, e.g., a WiFi direct P2P link or any other PTP link, for example, to enable direct communication between wireless communication devices 102 and/or 140.

In some demonstrative embodiments, wireless communication devices 102 and/or 140 may perform the functionality of WFD P2P devices. For example, devices 102 and/or 140 may be able to perform the functionality of a P2P client device, and/or P2P group Owner (GO) device.

In other embodiments, wireless communication devices 102 and/or 140 may form, and/or communicate as part of, any other network, and/or may perform the functionality of any other wireless devices or stations.

In some demonstrative embodiments, devices 102 and/or 140 may include one or more applications configured to provide, share, and/or to use one or more services, e.g., a social application, a file sharing application, a media application and/or the like, for example, using an awareness network, NAN network (“WiFi Aware network”), a PTP network, a P2P network, WFD network, or any other network.

In some demonstrative embodiments, device 102 may execute an application 125 and/or an application 126. In some demonstrative embodiments, device 140 may execute an application 145.

In some demonstrative embodiments, devices 102 and/or 140 may be capable of sharing, showing, sending, transferring, printing, outputting, providing, synchronizing, and/or exchanging content, data, and/or information, e.g., between applications and/or services of devices 102 and/or 140 and/or one or more other devices.

In some demonstrative embodiments, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative embodiments, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein.

In one example, controller 124 may perform one or more one or more operations and/or functionalities of, and/or may cause device 102 to perform one or more operations and/or functionalities of, a NAN engine, e.g., a NAN Discovery Engine (DE), for example to process one or more service queries and/or responses, e.g., from applications and/or services on devices 102 and/or 140, and/or one or more other devices.

In one example, controller 154 may perform one or more one or more operations and/or functionalities of, and/or may cause device 140 to perform one or more operations and/or functionalities of, a NAN engine, e.g., a NAN Discovery Engine (DE), for example to process one or more service queries and/or responses, e.g., from applications and/or services on devices 102 and/or 140, and/or one or more other devices.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below. In one example, message processor 128 may be configured to process transmission of one or more messages from a wireless station, e.g., a wireless STA implemented by device 102; and/or message processor 128 may be configured to process reception of one or more messages by a wireless station, e.g., a wireless STA implemented by device 102.

In some demonstrative embodiments, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below. In one example, message processor 158 may be configured to process transmission of one or more messages from a wireless station, e.g., a wireless STA implemented by device 140; and/or message processor 158 may be configured to process reception of one or more messages by a wireless station, e.g., a wireless STA implemented by device 140.

In some demonstrative embodiments, message processors 128 and/or 158 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In one example, message processors 128 and/or 158 may perform one or more one or more operations and/or functionalities of, and/or may cause a STA to perform one or more operations and/or functionalities of, a NAN MAC, which may be configured to generate, process and/or handle one or more NAN messages, e.g., NAN Beacon frames and/or NAN Service Discovery frames.

In some demonstrative embodiments, at least part of the functionality of message processor 128 may be implemented as part of radio 114.

In some demonstrative embodiments, at least part of the functionality of message processor 128 may be implemented as part of controller 124.

In other embodiments, the functionality of message processor 128 may be implemented as part of any other element of device 102.

In some demonstrative embodiments, at least part of the functionality of controller 124, radio 114, and/or message processor 128 may be implemented by an integrated circuit, for example, a chip, e.g., a System in Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In some demonstrative embodiments, at least part of the functionality of message processor 158 may be implemented as part of radio 144.

In some demonstrative embodiments, at least part of the functionality of message processor 158 may be implemented as part of controller 154.

In other embodiments, the functionality of message processor 158 may be implemented as part of any other element of device 140.

In some demonstrative embodiments, at least part of the functionality of controller 154, radio 144, and/or message processor 158 may be implemented by an integrated circuit, for example, a chip, e.g., a System in Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In some demonstrative embodiments, device 102 and/or device 140 may include, operate as, perform the role of, and/or perform one or more functionalities of, one or more STAs, for example, an awareness networking device, a NAN device, a WiFi device, a WiFi Aware device, a WFD device, a WLAN device and/or any other device, capable of discovering other devices according to a discovery protocol and/or scheme.

In some demonstrative embodiments, radios 114 and/or 144 may communicate over wireless communication medium 103 according to an awareness networking scheme, for example, a discovery scheme, for example, a WiFi Aware discovery scheme (“NAN discovery scheme”), and/or any other awareness networking and/or discovery scheme, e.g., as described below.

In some demonstrative embodiments, the awareness networking scheme, e.g., NAN, may enable applications to discover services in their close proximity. For example, the NAN technology may be a low power service discovery, which may, for example, scale efficiently, e.g., in dense Wi-Fi environments.

In some demonstrative embodiments, a device, e.g., wireless communication devices 102 and/or 140, may include one or more blocks and/or entities to perform network awareness functionality. For example, a device, e.g., devices 102 and/or 140, may be capable of performing the functionality of a NAN device, may include a NAN MAC and/or a Discovery Engine (DE). In one example, controllers 124 and/or 154 may be configured to perform the functionality of, and/or cause a STA to perform one or more operations of, the discovery engine, and/or message processors 128 and/or 158 may be configured to perform the functionality of, and/or cause a STA to perform one or more operations of, the NAN MAC, e.g., as described above. In another example, the functionality of the NAN MAC and/or the Discovery engine may be performed by any other element and/or entity of devices 102 and/or 140.

In some demonstrative embodiments, the awareness networking scheme may include a discovery scheme or protocol, e.g., as described below.

In some demonstrative embodiments, devices 102 and/or 140 may perform a discovery process according to the awareness networking scheme, for example, to discover each other and/or to establish a wireless communication link, e.g., directional and/or high throughput wireless communication link and/or any other link.

In some demonstrative embodiments, devices 102 and/or 140 may be configured to enable time synchronization between devices 102, 140 and/or one or more other devices, e.g., performing the functionality of Wi-Fi stations (STAs), for example, such that STAs can discover each other more efficiently and/or quickly.

Some demonstrative embodiments are described below with respect to a NAN discovery scheme, and to NAN discovery frames of the NAN discovery scheme. However, in other embodiments, any other discovery scheme and/or discovery frames may be used.

In some demonstrative embodiments, the discovery scheme may include a plurality of contention-based discovery windows (DWs).

In some demonstrative embodiments, communication during the DWs may be configured to enable time synchronization between Wi-Fi stations (STAs), e.g., devices 102 and/or 140, so that STAs can find each other more efficiently during a DW.

In some demonstrative embodiments, devices of an awareness network, e.g., a NAN network, may form one or more clusters, e.g., in order to publish and/or subscribe for services. A NAN cluster may be defined by an Anchor Master (AM) (also referred to as a “NAN master device” or “anchor device”). In one example, the AM may include a NAN device, which has the highest rank in the NAN cluster.

In some demonstrative embodiments, NAN data exchange may be reflected by discovery frames, e.g., Publish, Subscribe and/or Follow-Up Service discovery frames (SDF). These frames may include action frames, which may be sent by a device that wishes to publish a service/application, and/or to subscribe to a published service/application at another end.

In one example, one of devices 102 and/or 140, e.g., device 102, may include, operate as, perform a role of, and/or perform the functionality of, an AM. The AM may be configured to transmit one or more beacons. Another one of devices 102 and/or 140, e.g., device 140, may be configured to receive and process the beacons.

In one example, devices 102 and/or 140 may include, operate as, perform a role of, and/or perform the functionality of, NAN devices, e.g., belonging to a NAN cluster, which may share a common set of NAN parameters, for example, including a common NAN timestamp, and/or a common time period between consecutive discovery windows (DWs). The NAN timestamp may be communicated, for example, as part of a NAN beacon frame, which may be communicated in the NAN cluster. In one example, the NAN timestamp may include a Time Synchronization Function (TSF) value, for example, a cluster TSF value, or any other value.

In some demonstrative embodiments, devices 102 and/or 140 may be configured to discover one another over a predefined communication channel (“the social channel”). In one example, the Channel 6 in the 2.4 GHz band may be defined as the NAN social channel. Any other channel may be used as the social channel.

In some demonstrative embodiments, devices 102 and/or 140 may transmit discovery frames, e.g., SDFs, during the plurality of DWs, e.g., over the social channel. For example the NAN AM may advertise the time of the DW, during which NAN devices may exchange SDFs.

In one example, devices 102 and/or 140 may transmit the discovery frames to discover each other, for example, to enable using the one or more services provided by applications 125 and/or 126.

In some demonstrative embodiments, devices 102 and/or 140 may communicate during a DW according to a contention mechanism. For example, devices 102 and/or 140 may check whether or not a channel is unoccupied prior to an attempt to transmit a discovery frame during the discovery window.

In some demonstrative embodiments, a device of devices 102 and/or 140, e.g., device 102, may select not to transmit the discovery frame during the DW, e.g., if the channel is occupied. In some demonstrative embodiments, device 102 may transmit the discovery frame during the DW, e.g., if the channel is unoccupied.

In some embodiments, the discovery frame may be transmitted as a group addressed, e.g., broadcast or multicast, discovery frame. In other embodiments, the discovery frame may be transmitted as any other type of frame.

In some demonstrative embodiments, the discovery frame may not require an acknowledgement frame. According to these embodiments, a transmitter of the discovery frame may not backoff a transmission of the discovery frame.

In some demonstrative embodiments, the discovery frame transmitted by device 102 during the DW may be configured to enable other devices or services that are running on other devices to discover the services on device 102.

In some demonstrative embodiments, devices of system 100 may utilize availability information, e.g., in the form of an Availability Interval Bitmap and/or Further Availability Map, for example, to allow a device of devices 102 and/or 140, to advertise its availability, for example, in terms of at least one channel and one or more timeslots, during which the device may be available, e.g., active (“awake”), for example, to perform post NAN activities.

In one example, the availability information may be communicated as part of an Availability Attribute, e.g., including a 32-bit bitmap for 32 timeslots, for example, wherein each timeslot is 16 milliseconds (ms) long. For example, each bit that is not zero may represent a timeslot, during which a device sending the Availability Attribute is to be awake and available to send and/or receive data in a specified method.

In some demonstrative embodiments, devices 102 and/or 140 may be part of an awareness networking cluster, e.g., a NAN cluster.

In some demonstrative embodiments, the NAN cluster may include one or more other NAN devices.

In some demonstrative embodiments, devices 102 and/or 140 may be configured to communicate according to a Wi-Fi Aware specification and/or any other awareness networking specification, which may be configured to allow a group of devices to discover other devices/services nearby and/or in close proximity, e.g., with low power.

In some demonstrative embodiments, devices 102 and/or 140 may form the NAN cluster and may synchronize to the same clock, e.g., as described above.

In one example, all devices of the same cluster, e.g., the NAN cluster, may converge on a time period and channel, e.g., a DW, to facilitate the discovery of services of devices 102 and/or 140, and/or to achieve low power consumption, e.g., as described above.

In some demonstrative embodiments, devices 102 and/or 140 may be configured to enable data transmission for a specific service among multiple devices, post service discovery.

In some demonstrative embodiments, to enable data transmission post service discovery the two devices may be required to use a common schedule, e.g., to be available at a same channel at a same time.

In some demonstrative embodiments, devices 102 and/or 140 may be configured to utilize schemes, which may enable devices 102 and/or 140 to transmit data to each other, e.g., without any infrastructure, e.g., directly.

In some demonstrative embodiments, device 102 and/or device 140 may establish a Service Data Session (SDS), for example, to communicate, e.g., directly, between devices 102 and 140.

In some demonstrative embodiments, during the SDS, devices 102 and 140 may set up a NAN data link (NDL), e.g., to support the SDS and/or one or more other SDSs.

In some demonstrative embodiments, devices 102 and/or 140 may be configured to implement one or more operations of a data path schedule setup procedure for unicast service, e.g., in accordance with a NAN Specification.

In some demonstrative embodiments, device 102 and/or device 140, may be configured to create a NAN Data Link (NDL) with a data path schedule, for example, for transmission of services from one or more NAN data paths (NDP) between devices 102 and 140.

In some demonstrative embodiments, controller 124 may be configured to control, cause and/or trigger device 102 to set up an NDL with device 140.

In some demonstrative embodiments, controller 154 may be configured to control, cause and/or trigger device 140 to set up the NDL with device 102.

In some demonstrative embodiments, devices 102 and/or 140 may be configured to support one or more types of NDL in a data path setup, e.g., as described below.

In some demonstrative embodiment, the NDL may include a Synchronized NDL (S-NDL).

In some demonstrative embodiment, the NDL may include a paging NDL (P-NDL).

In some demonstrative embodiment, the NDL may include any other additional or alternative type of NDL.

In some demonstrative embodiments, devices 102 and/or 140 may be configured to communicate data between devices 102 and 140 during a Common Resource Block (CRB) of an NDL, e.g., as described below.

In some demonstrative embodiments, the CRB may include a block of resources, e.g., time resources and channel resources and/or any other resources, which may be synchronized, negotiated, and/or agreed upon, between two devices, e.g., devices 102 and/or 140, to be used for communication of an NDL.

In some demonstrative embodiments, a CRB may include one or more time slots to be utilized by devices 102 and 140 to communicate over a common wireless communication channel of an NDL, e.g., according to a P-NDL scheme, an S-NDL scheme, and/or any other NDL scheme.

In some demonstrative embodiments, the CRB nay include, for example, one or more contiguous time slots corresponding to a same wireless communication channel to communicate data of the NDL between first and second NAN devices.

In one example, a CRB may include a plurality of synchronized NAN Slots outside Discovery Windows (DWs) that are contiguous in a time domain, are in the same channel, and are shared by two or more NAN Devices to receive and/or transmit NAN frames between or among each other.

Some demonstrative embodiments are described herein with respect to NAN devices, e.g., device 102 and/or 140, communicating over an NDL according to an NDL scheme, e.g., a P-NDL scheme and/or an S-NDL scheme, utilizing one or more CRBs. However, in other embodiments, the NAN devices may communicate over an NDL according to an NDL scheme utilizing one or more additional or alternative resources, e.g., time slots, NDL time slots, resource blocks, channels, NDL resources, and the like.

In some demonstrative embodiments, according to a P-NDL scheme, there may be a paging window allocated in front of a CRB, for example, to allow a STA to indicate to a peer STA whether or not the STA has any traffic to be communicated to the peer STA during the CRB, e.g., as described below. For example, the peer STA may use the paging window in order to determine whether or not to enter a power save state during the CRB, e.g., as described below.

In some demonstrative embodiments, an S-NDL scheme may not include a paging window prior to a CRB.

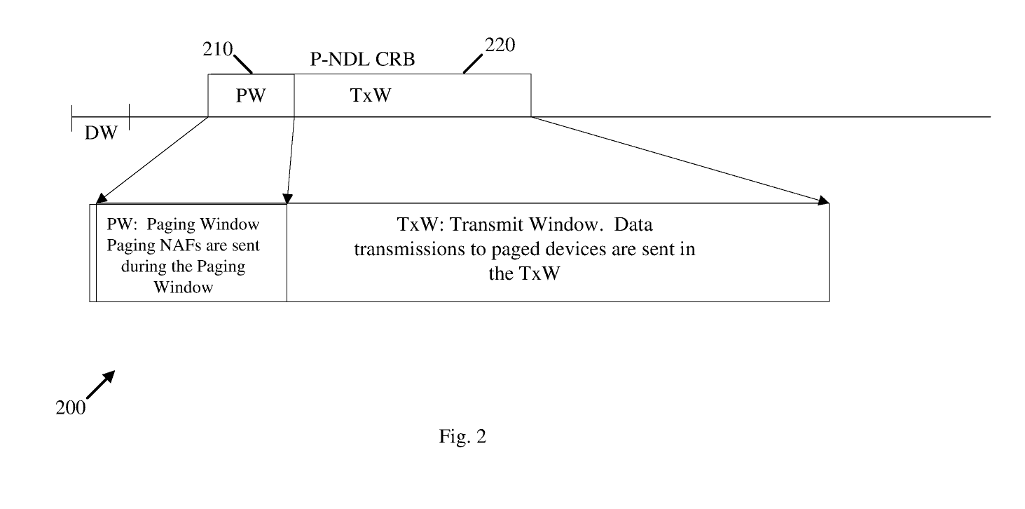

Reference is made to FIG. 2, which schematically illustrates a P-NDL scheme 200, in accordance with some demonstrative embodiments.

In some demonstrative embodiments, as shown in FIG. 2, according to P-NDL scheme 200, there may be a paging window 210 in front of an NDL time slot, e.g., a CRB 220.

In some demonstrative embodiments, CRB 220 may include one or more contiguous time slots to communicate data between two NAN devices, e.g., according to P-NDL scheme 200, over a same wireless communication channel.

In some demonstrative embodiments, paging window 210 may allow, for example, one or more STAs to check, e.g., during the paging window 210, for a paging message, which may indicate traffic information. For example, a first STA may transmit a paging message to a second STA during paging window 210, for example, to indicate that the first STA has traffic to send to the second STA during CRB 220. For example, the second STA may receive the paging message from the first STA during paging window 210, and may determine, for example, that the first STA has traffic to send to the second STA during CRB 220.

In some demonstrative embodiments, paging window 210 may enable a STA to decide, whether or not to enter a power save state for CRB 220, for example, based on the traffic information in the paging message, e.g., during paging window 210. For example, a STA may be able to decide if the STA can enter a power save state (“go to sleep”) in the rest of the time slot of the CRB 220, for example, based on the reception results of the paging message in the paging window, e.g., based on whether or not the STA is paged in the paging window 210.

Referring back to FIG. 1, in some demonstrative embodiments, it may not be advantageous to require a NAN device to remain awake during an entirety of an NDL time slot, e.g., during an entirety of a CRB.

In some demonstrative embodiments, for example, it may not be advantageous to require a NAN device, e.g., according to a NAN2 Specification, to be awake during an entire NDL slot, e.g., a CRB, allocated according to an S-NDL scheme.

For example, in a possible situation when two NAN devices of an NDL run out of traffic in the middle of a CRB, a requirement that both NAN devices are to stay awake for the rest of the CRB may not be advantageous, e.g., as it may result in a waste of power. A similar problem may occur for a P-NDL CRB, for example, in a situation where both NAN devices may run out of traffic in the middle of the time slot of a P-NDL.

One possible solution would be to implement a “unilateral power save agreement”, in which a first NAN device may end a frame, e.g., a schedule update frame with an unaligned schedule indication, to indicate that the first NAN device is not available for the rest of an NDL resource, e.g., a time slot or a CRB, and to allow the first NAN device to go to sleep. However, the unilateral power save agreement may not be able to provide a sufficient solution, for example, when a second NAN device may still have traffic to be sent to the first NAN device, and may want to continue data transmission over the NDL resource.

In some demonstrative embodiments, devices 102 and/or 140 may be configured to implement one or more operations and/or communications of a power save protocol with a bilateral power save agreement, e.g., as described below.

In some demonstrative embodiments, devices 102 and/or 140 may be configured to implement one or more operations and/or communications of a power save protocol for an NDL, e.g., S-NDL, a P-NDL and/or any other NDL, which may support a bilateral power save agreement in NAN, e.g., as described below.

In some demonstrative embodiments, devices 102 and/or 140 may be configured to support an exchange of a power save request and/or a power save response, for example, to allow two NAN devices, e.g., two NAN2 devices, to signal, negotiate and/or to agree on entering a power save state during at least part of an NDL resource, e.g., a CRB, of an NDL, for example, an S-NDL and/or a P-NDL, e.g., as described below.

In some demonstrative embodiments, the protocol for bilateral power save agreement may not necessarily exclude implementation of a protocol for the unilateral power save agreement, e.g., due to the existence of a schedule update frame. For example, in some cases the protocol for bilateral power save agreement may coexist with the protocol of the unilateral power save agreement.

In some demonstrative embodiments, in some use cases, deployments and/or scenarios, the protocol for bilateral power save agreement may be used, for example, in addition to and/or in support of, the unilateral power save agreement.

In some demonstrative embodiments, a protocol for signaling a bilateral power save agreement, may be implemented, for example, to enable a NAN device to enter a power save state, for example, during a resource of an NDL, for example, during at least part of a CRB of an S-NDL, and/or during a CRB of a P-NDL, e.g., as described below.

In some demonstrative embodiments, the protocol for bilateral power save agreement may define at least signaling of a power save request and/or a power save response, a behavior of STAs when transmitting or receiving the power save request and/or the power save response; a time period to enter a power save state, e.g., in response to the power save request and/or the power save response; and/or a time to wake up from the power save state, e.g., as described below.

In some demonstrative embodiments, two NAN devices having an NDL schedule, e.g., devices 102 and/or 140, may exchange a power save request and a power save response, for example, to signal, negotiate and/or coordinate entering into a power save state, e.g., as described below.

In some demonstrative embodiments, devices 102 and/or 140 may be configured to set up an NDL, for example, including one or more NDL resources, e.g., CRBs, e.g., as described above.

In some demonstrative embodiments, the NDL may include an S-NDL or a P-NDL. In other embodiments, the NDL may include any other type of NDL.

In some demonstrative embodiments, a CRB of the NDL may include one or more contiguous time slots to communicate data between devices 102 and 140 over a same wireless communication channel, e.g., as described above.

In some demonstrative embodiments, devices 102 and/or 140 may be configured to communicate a power save request between devices 102 and 140 during a CRB of the NDL, e.g., as describe below.

In some demonstrative embodiments, devices 102 and/or 140 may be configured to communicate a power save response between devices 102 and 140, e.g., as describe below.

In some demonstrative embodiments, the power save response may be in response to the power save request, e.g., as described below.

In some demonstrative embodiments, devices 102 and/or 140 may be configured to enter a power save state for at least part of the CRB, for example, based on the power save request and/or the power save response, e.g., as describe below.

In some demonstrative embodiments, devices 102 and/or 140 may be configured to cancel the request for power save, for example, by communicating another message or frame, e.g., as described below.

In some demonstrative embodiments, devices 102 and/or 140 may be configured to communicate a cancel message during the CRB, e.g., during the same CRB in which the power save request is communicated, for example, to cancel the power save request, e.g., as describe below.

In some demonstrative embodiments, the power save request may include, or may be included as part of, a NAN Action Frame (NAF) with a specific subtype, e.g., as describe below.

In one example, the NAF frame may include a power save request subtype.

In some demonstrative embodiments, the power save request may include, or may be included as part of, a frame, e.g., any frame, which indicates no traffic from a transmitter of the frame, e.g., as describe below.

In some demonstrative embodiments, the power save request may include, or may be included as part of, a frame including a More Data subfield, e.g., in a frame control field of the frame.

In some demonstrative embodiments, the More Data subfield of the power save request may include a value indicating no more traffic to transmit from the transmitter of the frame. For example, the More Data subfield may include a bit set to zero.

In one example, the frame including the power save request in the form of the More Data subfield in the frame control field may include, for example, a Quality of Service (QoS) Null frame, a QoS data frame, an Acknowledgement (Ack) frame, a Block Ack (BA) frame, and/or any other frame, for example, including the more data bit field set to zero.

In some demonstrative embodiments, the power save request may include, or may be included as part of, a frame, e.g., any frame, which indicates an End of Service Period (EOSP), e.g., as describe below.

In some demonstrative embodiments, the power save request may include, or may be included as part of, a frame including an EOSP subfield in a QoS control field of the frame.

In some demonstrative embodiments, the EOSP subfield of the power save request may include a value indicating an end of a service period. For example, the EOSP subfield may include a bit set to one.

In one example, the frame including the power save request in the form of the EOSP subfield in the QoS control field may include, for example, a QoS Null frame, a QoS data frame, an ACK frame, a BA frame, and/or any other frame, for example, including the EOSP bit field set to one.

In some demonstrative embodiments, the power save request may include, or may be included as part of, a frame, e.g., any frame, which indicates power management, e.g., as describe below.

In some demonstrative embodiments, the power save request frame may include, or may be included as part of, a frame including a Power Management subfield, e.g., in a frame control field of the frame.

In some demonstrative embodiments, the Power Management subfield of the power save request may include a value indicating a power save state. For example, the Power Management subfield may include a power management bit set to one.

In one example, the frame including the power save request in the form of the Power Management subfield may include, for example, a QoS Null frame, a QoS data frame, an ACK frame, a BA frame, and/or any other frame, for example, including the Power Management subfield set to one.

In other embodiments, the power save request may include, or may be included as part of, any other type of frame, and other field, and/or any other information element.

In some demonstrative embodiments, the power save response may include, or may be included as part if, a NAF frame with a specific subtype, e.g., as described below.

In one example, the NAF frame may include a power save response subtype.

In some demonstrative embodiments, the power save response may include, or may be included as part of, a frame, e.g., any frame, which indicates no traffic from a transmitter of the frame, e.g., as described below.

In some demonstrative embodiments, the power save response may include, or may be included as part of, a frame including the More Data subfield, e.g., in a frame control field of the frame.

In some demonstrative embodiments, the More Data subfield of the power save response may include the value indicating no more traffic to transmit from the transmitter of the frame. For example, the More Data subfield may include a bit set to zero.

In one example, the frame including the power save response in the form of the More Data subfield in the frame control field may include, for example, a QoS Null frame, a QoS data frame, an Ack frame, a BA frame, and/or any other frame, for example, including the More Data subfield set to zero.

In some demonstrative embodiments, the power save response may include, or may be included as part of, a frame, e.g., any frame, which indicates an EOSP, e.g., as described below.

In some demonstrative embodiments, the power save response may include, or may be included as part of, a frame including the EOSP subfield, e.g., in a QoS control field of the frame.

In some demonstrative embodiments, the EOSP subfield may include a value indicating an end of a service period. For example, the EOSP subfield may include a bit set to one.

In one example, the frame including the EOSP subfield of the power save response in the QoS control field may include, for example, a QoS Null frame, a QoS data frame, an ACK frame, a BA frame, and/or any other frame, for example, including the EOSP bit field set to one.

In some demonstrative embodiments, the power save response may include, or may be included as part of, a frame, e.g., any frame, which indicates power management, e.g., as described below.

In some demonstrative embodiments, the power save response frame may include, or may be included as part of, a frame including the Power Management subfield, e.g., in a frame control field of the frame.

In some demonstrative embodiments, the Power Management subfield of the power save response may include a value indicating a power save state. For example, the Power Management subfield may include a power management bit set to one.

In one example, the frame including the power save response in the form of the Power Management subfield may include, for example, a QoS Null frame, a QoS data frame, an ACK frame, a BA frame, and/or any other frame, for example, including the Power Management subfield set to one.

In other embodiments, the power save response may include, or may be included as part of, any other type of frame, and other field, and/or any other information element.

In some demonstrative embodiments, the cancel message may include, or may be included as part of, a NAF frame with a specific subtype.

In one example, the NAF frame may include a power save request subtype. For example, the NAF frame may include a control field including a value to indicate a cancellation operation (“cancel”).

In some demonstrative embodiments, the cancel message may include, or may be included as part of, a frame, e.g., any frame, which indicates no traffic from a transmitter of the frame, e.g., as described below.

In some demonstrative embodiments, the cancel message may include, or may be included as part of, a frame including the More Data subfield, e.g., in a frame control field of the frame.

In some demonstrative embodiments, the More Data subfield of the cancel message may include a value, which may be different from the value in the More Data subfield of the power save request frame. For example, the More Data subfield of the cancel message may include a bit set to one.

In one example, the frame including the cancel message in the from of the More Data subfield in the frame control field may include, for example, a QoS Null frame, a QoS data frame, an Ack frame, a BA frame, and/or any other frame, for example, including the More Data subfield set to one.

In some demonstrative embodiments, the cancel message may include, or may be included as part of, a frame, e.g., any frame, which indicates an EOSP, e.g., as described below.

In some demonstrative embodiments, the cancel message may include, or may be included as part of, a frame including the EOSP subfield, e.g., in a QoS control field of the frame.

In some demonstrative embodiments, the EOSP subfield of the cancel message may include a value, which may be different from the value of the EOSP subfield in the power save request frame. For example, the EOSP subfield of the cancel message may include a bit set to zero.

In one example, the frame including the cancel message in the form of the EOSP subfield in the QoS control field may include, for example, a QoS Null frame, a QoS data frame, an ACK frame, a BA frame, and/or any other frame, for example, including the EOSP bit set to zero.

In some demonstrative embodiments, the cancel message may include, or may be included as part of, a frame, e.g., any frame, which indicates power management, e.g., as described below.

In some demonstrative embodiments, the cancel message frame may include, or may be included as part of, a frame including the Power Management subfield, e.g., in a frame control field of the frame.

In some demonstrative embodiments, the Power Management subfield of the cancel message may include a value, which may be different from the value of the Power Management subfield in the power save request frame. For example, the Power Management subfield of the cancel message may include a power management bit set to zero.

In one example, the frame including the cancel message in the form of the Power Management subfield may include, for example, a QoS Null frame, a QoS data frame, an ACK frame, a BA frame, and/or any other frame, for example, including the Power Management subfield set to zero.

In other embodiments, the cancel message may include, or may be included as part of, any other type of frame, and other field, and/or any other information element.

In some demonstrative embodiments, device 102 may be configured to transmit the power save request and/or the cancel message to device 140, and/or to process the power save response from device 140, e.g., as described below.

In some demonstrative embodiments, device 140 may be configured to process the power save request and/or the cancel message from device 102, and/or to transmit the power save response to device 102, e.g., as described below.

In some demonstrative embodiments, controller 124 may be configured to control, cause and/or trigger device 102 to transmit the power save request to device 140.

In one example, controller 124 may be configured to control, cause and/or trigger message processor 128 to generate the power save request, and/or controller 124 may be configured to control, cause and/or trigger transmitter 118 to transmit the power save request to device 140.

In some demonstrative embodiments, device 140 may receive the power save request from device 102.

In some demonstrative embodiments, controller 154 may be configured to control, cause and/or trigger device 140 to process the power save request from device 102.

In one example, controller 154 may be configured to control, cause and/or trigger receiver 146 to receive the power save request from device 102, and/or controller 154 may be configured to control, cause and/or trigger message processor 158 to process the power save request.

In some demonstrative embodiments, controller 154 may be configured to control, cause and/or trigger device 140 to transmit the power save response to device 102.

In one example, controller 154 may be configured to control, cause and/or trigger message processor 158 to generate the power save response, and/or controller 154 may be configured to control, cause and/or trigger transmitter 148 to transmit the power save response to device 102.

In some demonstrative embodiments, device 102 may receive the power save request from device 140.

In some demonstrative embodiments, controller 124 may be configured to control, cause and/or trigger device 102 to process the power save response from device 140.

In one example, controller 124 may be configured to control, cause and/or trigger receiver 116 to receive the power save response from device 140, and/or controller 124 may be configured to control, cause and/or trigger message processor 128 to process the power save response.

In some demonstrative embodiments, devices 102, and/or 140 may be configured to perform one or more operations of a STA, which transmits or receives the signaling of power save request/response, e.g., as described below.

In some demonstrative embodiments, a NAN device, e.g., a NAN2 device, for example, device 102, which sends a power save request frame, may be allowed enter a sleep state, for example, when receiving a power save response frame.

In some demonstrative embodiments, a NAN device, e.g., a NAN2 device, for example, device 140, which sends a power save response frame, may be allowed to enter a sleep state.

In some demonstrative embodiments, a NAN device, e.g., a NAN2 device, for example, device 140, which sends a power save response frame, may be allowed to enter the sleep state, for example, upon receiving an acknowledgement for the power save response frame, e.g., if the power save response frame requires acknowledgement.

In some demonstrative embodiments, a NAN device, e.g., a NAN2 device, which receives the power save request frame, e.g., device 140, may be allowed to enter the sleep state.

In some demonstrative embodiments, controller 124 may be configured to control, cause and/or trigger device 102 to enter the power save state, for example, upon or after receipt of the power save response from device 140.

In some demonstrative embodiments, controller 154 may be configured to control, cause and/or trigger device 140 to enter the power save state, for example, upon or after transmission of the power save response from device 140.

In some demonstrative embodiments, controller 154 may be configured to control, cause and/or trigger device 140 to enter the power save state, for example, upon or after reception of the power save request from device 102.

In some demonstrative embodiments, device 140 may enter the power save state, for example, only upon or after reception of an acknowledge frame from device 102, for example, if the power save response requires an acknowledgement.

In some demonstrative embodiments, the acknowledge frame may be configured to acknowledge reception of the power save response from device 140 by device 102.

In some demonstrative embodiments, controller 154 may be configured to control, cause and/or trigger device 140 to enter the power save state, for example, after reception of the acknowledge frame from device 102.

In some demonstrative embodiments, device 102 may transmit a cancel message to device 140, for example, to cancel a power save request and/or to cancel a power save period negotiated with device 140, e.g., as described below.

In some demonstrative embodiments, controller 124 may be configured to control, cause and/or trigger device 102 to transmit the cancel message to device 140.

In one example, controller 124 may be configured to control, cause and/or trigger message processor 128 to generate the cancel message, and/or controller 124 may be configured to control, cause and/or trigger transmitter 118 to transmit the cancel message to device 140.

In some demonstrative embodiments, device 140 may receive the cancel message from device 102.

In some demonstrative embodiments, controller 154 may be configured to control, cause and/or trigger device 140 to process the cancel message from device 102.

In one example, controller 154 may be configured to control, cause and/or trigger receiver 146 to receive the cancel message from device 102, and/or controller 154 may be configured to control, cause and/or trigger message processor 158 to process the cancel message.

In some demonstrative embodiments, one or more of the above operations for transmitting and/or receiving the power save request and/or the power save response may be valid for a peer NAN device, e.g., peer NAN2 devices, for example, only in a defined period, e.g., as described below.

In some demonstrative embodiments, the period may be started, for example, when a power save request is sent/received, e.g., as described below.

In some demonstrative embodiments, the period may end, for example, when a power save response is sent/received, e.g., as described below.

In some demonstrative embodiments, the period may end, for example, if a power save request is cancelled before a power save response is sent/received, e.g., as described below.

In some demonstrative embodiments, the period may end, for example, if a current contiguous time slot, e.g., a CRB, ends. For example, power save operation for slots in different channels may be independent, e.g., as described below.

In some demonstrative embodiments, the period may end, for example, if a defined continuous time has passed, e.g., as described below.

In some demonstrative embodiments, the period may end, for example, for a combination of the above conditions and/or one or more other conditions and/or criteria.

In some demonstrative embodiments, a NAN device, e.g., device 102 and/or device 140, exchanging the power save request and the power save response may be allowed to enter the power save sate, for example, only if the exchange of the power save request and the power save response is within a defined period (“the exchange period” or “signaling period”), e.g., as described below.

In some demonstrative embodiments, the exchange period may begin, for example, when a power save request is sent or received, e.g., by the NAN device.

In some demonstrative embodiments, the exchange period may end, for example, when a power save response is sent or received, e.g., by the NAN device.

In some demonstrative embodiments, the exchange period may end, for example, if a power save request is cancelled before a power save response is sent or received, e.g., by the NAN device.

In some demonstrative embodiments, the exchange period may end, for example, if a current NDL resource, e.g., a current CRB, ends. For example, according to this criterion, power save operation for CRBs in different channels may be independent.

In some demonstrative embodiments, the exchange period may end, for example, if a predefined duration has passed.

In some demonstrative embodiments, the exchange period may end, for example, for a combination of two or more of above conditions and/or one or more additional or alternative conditions and/or criteria.

In some demonstrative embodiments, a NAN device may be allowed to enter the power save state, for example, after exchanging the power save request and the power save response, e.g., as described above.

In some demonstrative embodiments, a NAN device may be allowed to remain in the power save state for a period (“power save period” or “sleep period”), which may be determined, configured, and/or defined, e.g., as described below.

In some demonstrative embodiments, a duration of the power save period may be determined, for example, according to a remaining time of a contiguous time slot in the same channel, e.g., a remaining duration of a CRB, e.g., the CRB in which the power save request and response are exchanged.

In some demonstrative embodiments, controller 124 may be configured to control, cause and/or trigger device 102 to allow device 102 to remain in the power save state until an end of the CRB, for example, until an end of the same CRB during which the power save request and response are exchanged with device 140, e.g., as described below.

In some demonstrative embodiments, controller 154 may be configured to control, cause and/or trigger device 140 to allow device 140 to remain in the power save state until the end of the CRB, for example, until an end of the same CRB during which the power save request and response are exchanged with device 102, e.g., as described below.

In some demonstrative embodiments, the duration of the power save period may be indicated in the power save request and/or the power save response. For example, allowing a NAN device to indicate the duration of the power save period to a peer NAN device may be useful, for example, in a situation where a duration of the CRB in the same channel is long, e.g., a CRB duration of at least 512 microseconds (ms), or any other shorter or longer CRB duration.

In one example, allowing a NAN device, e.g., device 102 and/or device 140, to indicate, signal, and/or negotiate the duration of the power save period may enable to terminate the power save period, for example, even prior to an end of the CRB, e.g., to allow further communication of traffic during the CRB, e.g., as described below.

In some demonstrative embodiments, controller 124 may be configured to control, cause and/or trigger device 102 to allow device 102 to remain in the power save state for a power save period having a duration indicated in the power save request and/or the power save response exchanged between devices 102 and 140.

In some demonstrative embodiments, controller 154 may be configured to control, cause and/or trigger device 140 to allow device 140 remain in the power save state for the power save period having a duration indicated in the power save request and/or the power save response exchanged between devices 102 and 140.

In one example, controller 124 may be configured to cause device 102 to include in the power save request a duration value to indicate the duration of the power save period.

In one example, controller 154 may be configured to cause device 154 to include in the power save response a duration value to indicate the duration of the power save period.

In some demonstrative embodiments, the duration of the power save period may be preconfigured, for example, according to a NAN Specification. For example, a duration of the power save period may be defined as having a length of 16 ms, 32 ms, or any other duration. For example, using a preconfigured duration may be useful, for example, in a situation where a duration of the CRB in the same channel is long, e.g., a CRB duration of 512 ms or any other CRB duration.

In one example, setting the duration of the power save period to a preconfigured duration may enable to terminate the power save period, for example, even prior to an end of the CRB, e.g., to allow further communication of traffic during the CRB, e.g., as described below.

In some demonstrative embodiments, controller 124 may be configured to control, cause and/or trigger device 102 to allow device 102 to remain in the power save state for a preconfigured power save period within the CRB.

In some demonstrative embodiments, controller 154 may be configured to control, cause and/or trigger device 140 to allow device 140 to remain in the power save state for the preconfigured power save period within the CRB.

In some demonstrative embodiments, the preconfigured power save period may be shorter than a duration of the CRB.

In some demonstrative embodiments, the duration of the power save period may be indicated, for example, in a setup of the NDL between devices 102 and 140. For example, the duration of the preconfigured power save period may be signaled, for example, as part of a data path request frame and/or a data path response frame, e.g., when setting up the NDL between devices 102 and 140.

In one example, controller 124 may be configured to cause device 102 to a duration value to indicate the duration of the power save period in an NDL setup message, e.g., an NDL request message or an NDL response message.

In one example, controller 154 may be configured to cause device 154 to a duration value to indicate the duration of the power save period in an NDL setup message, e.g., an NDL request message or an NDL response message.

In some demonstrative embodiments, the duration of the power save period may be indicated, for example, in a setup of an NDP between devices 102 and 140. For example, the duration of the preconfigured power save period may be signaled, for example, as part of a data path request frame and/or a data path response frame, e.g., when setting up the NDP between devices 102 and 140.

In one example, controller 124 may be configured to cause device 102 to a duration value to indicate the duration of the power save period in an NDP setup message, e.g., an NDP request message or an NDP response message.

In one example, controller 154 may be configured to cause device 154 to a duration value to indicate the duration of the power save period in an NDP setup message, e.g., an NDP request message or an NDP response message.

In some demonstrative embodiments, the duration of the power save period may be determined, for example, as a combination of two or more of the schemes and/or options described above, and/or according to any other scheme and/or option. For example, the duration of the power save period may be set as a portion of the remaining time of the CRB, or a portion of the preconfigured power save period.

In some demonstrative embodiments, a NAN STA may be configured to wake up, for example, periodically, e.g., at a beginning of an NDL resource block, for example, a CRB, e.g., in accordance with a NAN Specification.

In some demonstrative embodiments, a NAN STA may be configured to operate at a power save state for a power save period during a CRB, for example, based on a power save request and/or a power save response, which may be communicated with a peer NAN STA during the CRB, e.g., as described above.

In some demonstrative embodiments, the NAN STA may be configured to wake up from the power save state during the CRB, for example, if the duration of the power save period ends within the CRB, e.g., before the CRB ends.

In some demonstrative embodiments, controller 124 may be configured to control, cause and/or trigger device 102 to wakeup device 102 at an end of the power save period.

In some demonstrative embodiments, controller 154 may be configured to control, cause and/or trigger device 140 to wakeup device 140 at the end of the power save period.

In some demonstrative embodiments, devices 102 and 140 may be configured to enter the power save state, for example, even more than one time during a CRB, for example, if the duration of the power save period is shorter than the duration of the CRB, and/or if a duration of the CRB is very long.

In one example, the duration the power save period may be defined as having a length of 16 ms, 32 ms, and the duration of the CRB may be 512 ms. According to this example, devices 102 and/or 140 may be allowed to switch between a power save state and an active state multiple times within the same CRB.

In some demonstrative embodiments, devices 102 and 140 may exchange a sequence of power save signaling messages, e.g., a power save request and a power save response, for example, prior to entering into a power save period, e.g., during the CRB. Devices 102 and 140 may exchange the sequence of power save signaling messages for one or more times during a CRB, e.g., to enter the power save state for one or more respective periods during the CRB.

In some demonstrative embodiments, a bilateral power save agreement, e.g., as described above, may enable devices 102 and 140 to enter a power save state during, e.g., even within, a CRB of an NDL, for example, an S-NDL or a P-NDL, e.g., as described above.

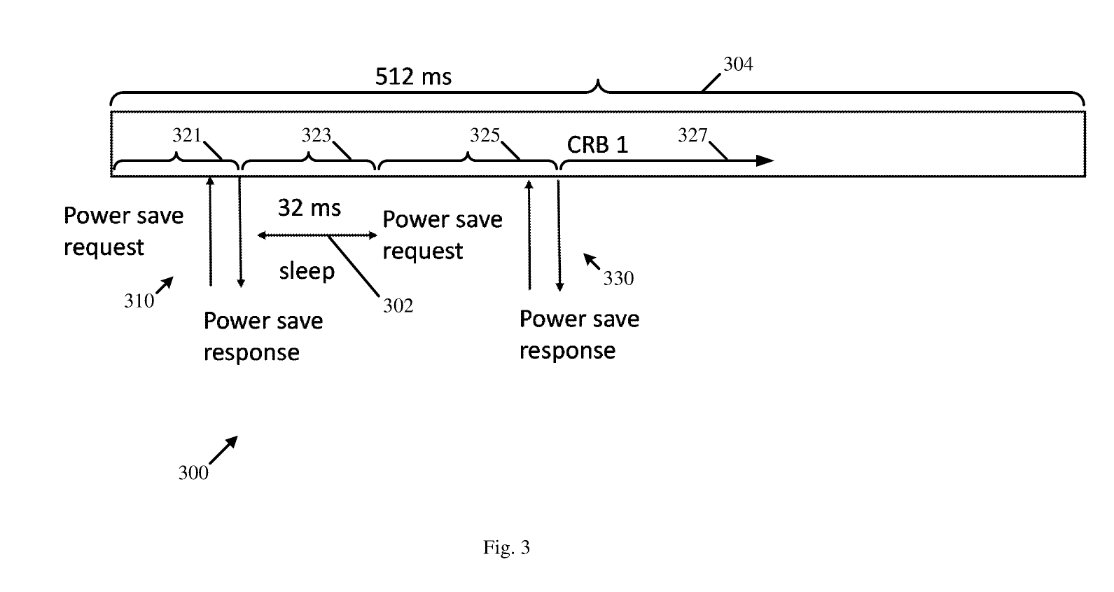

Reference is made to FIG. 3, which schematically illustrates scheduling one or more power save periods during a CRB 300, in accordance with some demonstrative embodiments.

In some demonstrative embodiments, CRB 300 may be setup for communication over an NDL between a first NAN device, e.g., device 102 (FIG. 1), and a second NAN device, e.g., device 140 (FIG. 1).

In some demonstrative embodiments, as shown in FIG. 3, the CRB 300 may have a duration 304 of 512 ms.

In some demonstrative embodiments, as shown in FIG. 3, the first and second NAN devices may be at an active state at a beginning of the CRB 300, for example, during a time period 321.

In some demonstrative embodiments, as shown in FIG. 3, the first and second NAN devices may exchange a sequence 310 of a power save request and a power save response during period 321, for example, to signal and/or negotiate a power save period 323.

In some demonstrative embodiments, as shown in FIG. 3, the power save period may have a duration 302 of 32 ms. For example, the duration of power save period 323 may be preconfigured, signaled and/or negotiated between the first and second NAN devices, e.g., as described above.

In some demonstrative embodiments, the first and second NAN devices may be allowed to exit the power save state, e.g., to switch back to the active state, for example, at and end of power save period 302.

In some demonstrative embodiments, as shown in FIG. 3, the relatively short duration 302 of power save period 323, e.g., compared to the duration 304 of CRB 300, may enable the first and second NAN devices to switch between the active state and the power save state one or more times during CRB 300.

In some demonstrative embodiments, as shown in FIG. 3, the first and second NAN devices may be at an active state, for example, during a time period 325 following power save period 323.

In some demonstrative embodiments, as shown in FIG. 3, the first and second NAN devices may exchange a sequence 330 of a power save request and a power save response during period 325, for example, to signal and/or negotiate a subsequent power save period 327 during CRB 300. In one example, the subsequent power save period 327 may have a same duration 302 as power save period 323. In another example, the subsequent power save period 327 may have a duration different from the duration 302 as power save period 323. For example, the subsequent power save period 327 may be extended until an end of CRB 300.

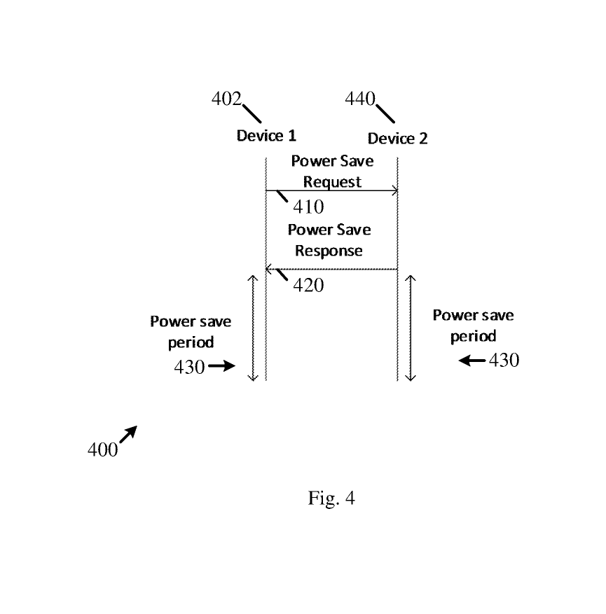

Reference is made to FIG. 4, which schematically illustrates a sequence diagram 400 of operations and/or communication between a first NAN device 402 and a second NAN device 440, in accordance with some demonstrative embodiments. For example, device 402 may operate as, perform a role of, and/or perform the functionality of, device 102 (FIG. 1), and/or device 402 may operate as, perform a role of, and/or perform the functionality of, device 140 (FIG. 1).

In some demonstrative embodiments, as shown in FIG. 4, device 402 may transmit a power save request 410 to device 440. For example, device 102 (FIG. 1) may transmit power save request 410 to device 140 (FIG. 1).

In some demonstrative embodiments, as shown in FIG. 4, device 440 may transmit a power save response 420 to device 402, e.g., in response to power save request 410. For example, device 140 (FIG. 1) may transmit power save response 420 to device 102 (FIG. 1).

In some demonstrative embodiments, as shown in FIG. 4, devices 402 and 440 may be allowed to enter a power save state during a power save period 430, for example, after exchanging power save request 410 and power save response 420.

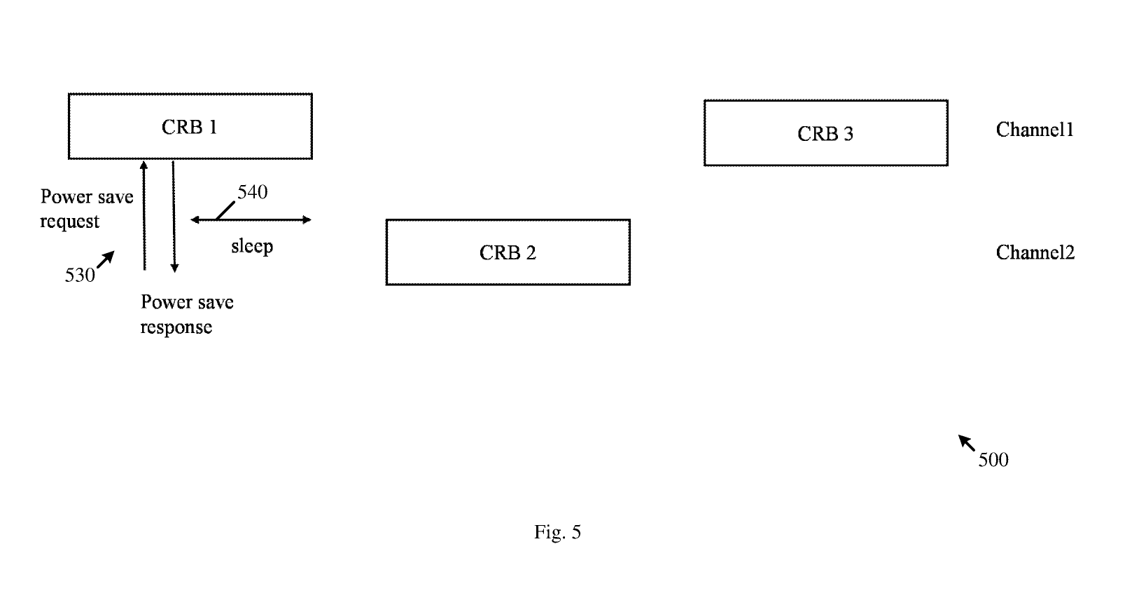

Reference is made to FIG. 5, which schematically illustrates scheduling of a power save period during a CRB according to an S-NDL scheme 500, in accordance with some demonstrative embodiments.

In some demonstrative embodiments, as shown in FIG. 5, S-NDL scheme 500 may include one or more CRBs, e.g., including a sequence of three CRBs, denoted CRB1, CRB2 and CRB3, over one or more channels, e.g., two channels, denoted Channel1 and Channel 2.

In some demonstrative embodiments, as shown in FIG. 5, two NAN devices, e.g., devices 102 and 140 (FIG. 1), may be able to enter a power save state 540 during a CRB, e.g., CRB1, for example, after exchanging (530) a power save request and a power save response between the two NAN devices during the CRB.

In some demonstrative embodiments, as shown in FIG. 5, the two NAN devices, e.g., devices 102 and 140 (FIG. 1), may be allowed to remain in the power save state, for example, during a remainder of the CRB1.

In some demonstrative embodiments, the two NAN devices, e.g., devices 102 and 140 (FIG. 1), may be awake at a beginning of a subsequent CRB, e.g., CRB2 and/or CRB3.

In some demonstrative embodiments, the two NAN devices, e.g., devices 102 and 140 (FIG. 1), may be able to enter the power save state during the subsequent CRB, e.g., CRB2 and/or CRB3, for example, after another exchange of a power save request and a power save response between the two NAN devices during the subsequent CRB.

In one example, the two NAN devices, e.g., devices 102 and 140 (FIG. 1), may select to remain awake during CRB2, for example, to communicate traffic between the two NAN devices during the CRB2. According to this example, the two NAN devices, e.g., devices 102 and 140 (FIG. 1), may select not to exchange the power save request and/or the power save response during CRB2.

In one example, the two NAN devices, e.g., devices 102 and 140 (FIG. 1), may be allowed to switch to the power save state during CRB3, for example, after exchanging the power save request and/or the power save response during CRB3.

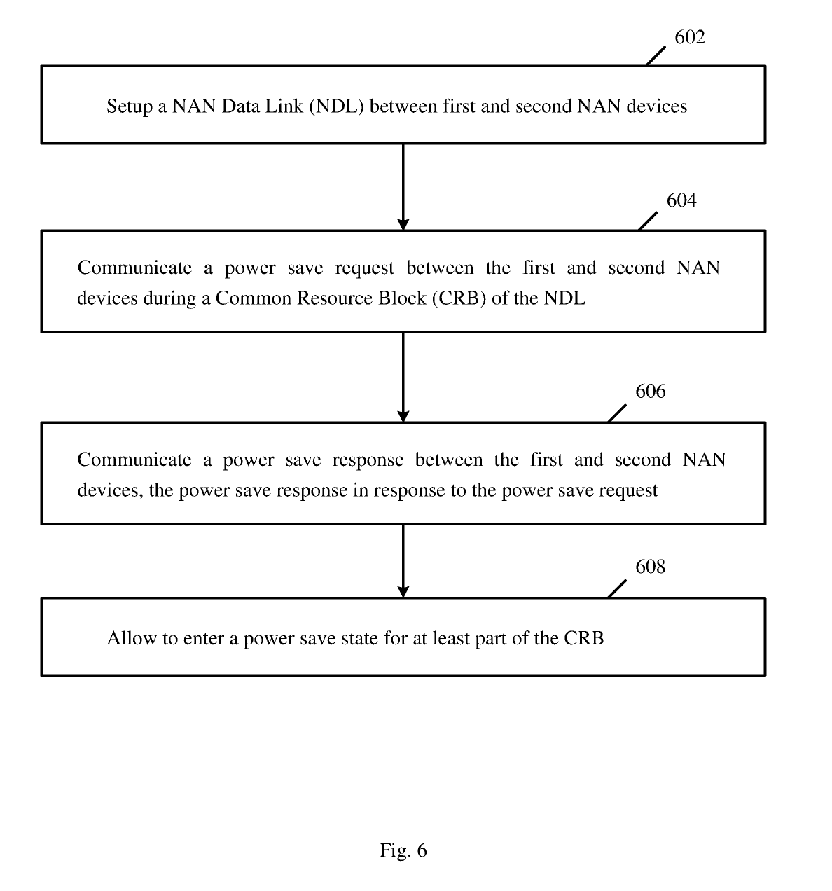

Reference is made to FIG. 6, which schematically illustrates a method of an NDL power save, in accordance with some demonstrative embodiments. For example, one or more of the operation of FIG. 6 may be performed by one or more elements of a system, system 100 (FIG. 1); a device, e.g., wireless communication devices 102 and/or 140 (FIG. 1); a controller, e.g., controller 124 (FIG. 1), and/or controller 154 (FIG. 1); a radio, e.g., radio 114 (FIG. 1); and/or radio 144 (FIG. 1); and/or a message processor, e.g., message processor 128 (FIG. 1) and/or message processor 158 (FIG. 1).

As indicated at block 602, the method may include setting up a NAN Data link (NDL) between first and second NAN devices. For example, devices 102 and/or 140 (FIG. 1) may setup the NDL, e.g., as described above.

As indicated at block 604, the method may include communicating a power save request between the first and second NAN devices during a CRB of the NDL. For example, devices 102 and/or 140 (FIG. 1) may communicate the power save request 410 (FIG. 4) during CRB1 (FIG. 5), e.g., as described above.

As indicated at block 606, the method may include communicating a power save response between the first and second NAN devices, e.g., in response to the power save request. For example, devices 102 and/or 140 (FIG. 1) may communicate the power save response 420 (FIG. 4) in response to power save request 410 (FIG. 4), e.g., as described above.

As indicated at block 608, the method may include entering a power save state for at least part at least part of the CRB. For example, devices 102 and/or 140 (FIG. 1) may enter power save state during the power save period 540 (FIG. 5) of CRB1 (FIG. 5), e.g., as described above.

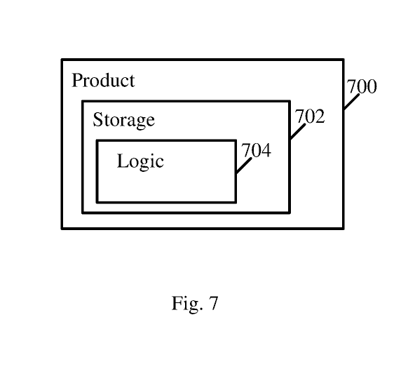

Reference is made to FIG. 7, which schematically illustrates a product of manufacture 700, in accordance with some demonstrative embodiments. Product 700 may include one or more tangible computer-readable non-transitory storage media 702, which may include computer-executable instructions, e.g., implemented by logic 704, operable to, when executed by at least one computer processor, enable the at least one computer processor to implement one or more operations at devices 102 and/or 140 (FIG. 1), radio 114 (FIG. 1), transmitter 118 (FIG. 1), receiver 116 (FIG. 1), controller 124, controller 154 (FIG. 1), message processor 128 (FIG. 1), message processor 158 (FIG. 1), and/or to perform, trigger and/or implement one or more operations and/or functionalities described with reference to the FIGS. 1, 2, 3, 4, 5, and/or 6, and/or one or more operations described herein. The phrase “non-transitory machine-readable medium” is directed to include all computer-readable media, with the sole exception being a transitory propagating signal.

In some demonstrative embodiments, product 700 and/or machine-readable storage media 702 may include one or more types of computer-readable storage media capable of storing data, including volatile memory, non-volatile memory, removable or non-removable memory, erasable or non-erasable memory, writeable or re-writeable memory, and the like. For example, machine-readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes an apparatus comprising logic and circuitry configured to cause a first Neighbor Awareness Networking (NAN) device to setup a NAN Data Link (NDL) with a second NAN device; communicate a power save request between the first and second NAN devices during a Common Resource Block (CRB) of the NDL; communicate a power save response between the first and second NAN devices, the power save response in response to the power save request; and enter a power save state for at least part of the CRB.

Example 2 includes the subject matter of Example 1, and optionally, wherein the apparatus is configured to cause the first NAN device to transmit the power save request to the second NAN device, and to enter the power save state after receipt of the power save response from the second NAN device.

Example 3 includes the subject matter of Example 1, and optionally, wherein the apparatus is configured to cause the first NAN device to process the power save request from the second NAN device, and to transmit the power save response to the second NAN device.

Example 4 includes the subject matter of Example 3, and optionally, wherein the apparatus is configured to cause the first NAN device to enter the power save state after transmission of the power save response from the first NAN device.

Example 5 includes the subject matter of Example 3, and optionally, wherein the apparatus is configured to cause the first NAN device to enter the power save state after reception of an acknowledge frame from the second NAN device, the acknowledge frame to acknowledge reception of the power save response by the second NAN device.

Example 6 includes the subject matter of any one of Examples 1-5, and optionally, wherein the apparatus is configured to allow the first NAN device to remain in the power save state until an end of the CRB.

Example 7 includes the subject matter of any one of Examples 1-6, and optionally, wherein the apparatus is configured to allow the first NAN device to remain in the power save state for a power save period having a preconfigured duration within the CRB.

Example 8 includes the subject matter of Example 7, and optionally, wherein the apparatus is configured to wake up the first NAN device at an end of the power save period.

Example 9 includes the subject matter of Example 7 or 8, and optionally, wherein the preconfigured duration is shorter than a duration of the CRB.

Example 10 includes the subject matter of any one of Examples 1-9, and optionally, wherein the apparatus is configured to allow the first NAN device to remain in the power save state for a power save period having a duration indicated in at least one of the power save request or the power save response.

Example 11 includes the subject matter of any one of Examples 1-10, and optionally, wherein the apparatus is configured to cause the first NAN device to communicate a cancel message to cancel the power save request during the CRB.

Example 12 includes the subject matter of any one of Examples 1-11, and optionally, wherein the power save request comprises a More Data subfield in a frame control field, the More Data subfield comprises a value to indicate no more traffic to transmit.

Example 13 includes the subject matter of any one of Examples 1-11, and optionally, wherein the power save request comprises an End Of Service Period (EOSP) subfield in a QoS control field, the EOSP subfield comprises a value to indicate an end of a service period.

Example 14 includes the subject matter of any one of Examples 1-13, and optionally, wherein the power save response comprises a Power Management subfield in a frame control field, the Power Management subfield comprises a value to indicate a power save state.

Example 15 includes the subject matter of any one of Examples 1-14, and optionally, wherein the NDL comprises a Synchronized NDL (S-NDL).

Example 16 includes the subject matter of any one of Examples 1-14, and optionally, wherein the NDL comprises a Paging NDL (P-NDL).

Example 17 includes the subject matter of any one of Examples 1-16, and optionally, wherein the CRB comprises one or more contiguous time slots corresponding to a same wireless communication channel to communicate data of the NDL between the first and second NAN devices.

Example 18 includes the subject matter of any one of Examples 1-17, and optionally, comprising a radio to communicate the power save request and the power save response.

Example 19 includes the subject matter of any one of Examples 1-18, and optionally, comprising one or more antennas, a processor, and a memory.

Example 20 includes a system of wireless communication comprising a first Neighbor Awareness Networking (NAN) device, the first NAN device comprising one or more antennas; a radio; a memory; a processor; and a controller configured to cause the first NAN device to setup a NAN Data Link (NDL) with a second NAN device; communicate a power save request between the first and second NAN devices during a Common Resource Block (CRB) of the NDL; communicate a power save response between the first and second NAN devices, the power save response in response to the power save request; and enter a power save state for at least part of the CRB.

Example 21 includes the subject matter of Example 20, and optionally, wherein the controller is configured to cause the first NAN device to transmit the power save request to the second NAN device, and to enter the power save state after receipt of the power save response from the second NAN device.

Example 22 includes the subject matter of Example 20, and optionally, wherein the controller is configured to cause the first NAN device to process the power save request from the second NAN device, and to transmit the power save response to the second NAN device.

Example 23 includes the subject matter of Example 22, and optionally, wherein the controller is configured to cause the first NAN device to enter the power save state after transmission of the power save response from the first NAN device.

Example 24 includes the subject matter of Example 22, and optionally, wherein the controller is configured to cause the first NAN device to enter the power save state after reception of an acknowledge frame from the second NAN device, the acknowledge frame to acknowledge reception of the power save response by the second NAN device.

Example 25 includes the subject matter of any one of Examples 20-24, and optionally, wherein the controller is configured to allow the first NAN device to remain in the power save state until an end of the CRB.

Example 26 includes the subject matter of any one of Examples 20-25, and optionally, wherein the controller is configured to allow the first NAN device to remain in the power save state for a power save period having a preconfigured duration within the CRB.

Example 27 includes the subject matter of Example 26, and optionally, wherein the controller is configured to wake up the first NAN device at an end of the power save period.

Example 28 includes the subject matter of Example 26 or 27, and optionally, wherein the preconfigured duration is shorter than a duration of the CRB.

Example 29 includes the subject matter of any one of Examples 20-28, and optionally, wherein the controller is configured to allow the first NAN device to remain in the power save state for a power save period having a duration indicated in at least one of the power save request or the power save response.

Example 30 includes the subject matter of any one of Examples 20-29, and optionally, wherein the controller is configured to cause the first NAN device to communicate a cancel message to cancel the power save request during the CRB.

Example 31 includes the subject matter of any one of Examples 20-30, and optionally, wherein the power save request comprises a More Data subfield in a frame control field, the More Data subfield comprises a value to indicate no more traffic to transmit.

Example 32 includes the subject matter of any one of Examples 20-30, and optionally, wherein the power save request comprises an End Of Service Period (EOSP) subfield in a QoS control field, the EOSP subfield comprises a value to indicate an end of a service period.

Example 33 includes the subject matter of any one of Examples 20-32, and optionally, wherein the power save response comprises a Power Management subfield in a frame control field, the Power Management subfield comprises a value to indicate a power save state.

Example 34 includes the subject matter of any one of Examples 20-33, and optionally, wherein the NDL comprises a Synchronized NDL (S-NDL).

Example 35 includes the subject matter of any one of Examples 20-33, and optionally, wherein the NDL comprises a Paging NDL (P-NDL).

Example 36 includes the subject matter of any one of Examples 20-35, and optionally, wherein the CRB comprises one or more contiguous time slots corresponding to a same wireless communication channel to communicate data of the NDL between the first and second NAN devices.

Example 37 includes the subject matter of any one of Examples 20-36, and optionally, wherein the radio is to communicate the power save request and the power save response.

Example 38 includes a method to be performed at a first Neighbor Awareness Networking (NAN) device, the method comprising setting up a NAN Data Link (NDL) with a second NAN device; communicating a power save request between the first and second NAN devices during a Common Resource Block (CRB) of the NDL; communicating a power save response between the first and second NAN devices, the power save response in response to the power save request; and entering a power save state for at least part of the CRB.

Example 39 includes the subject matter of Example 38, and optionally, comprising transmitting the power save request to the second NAN device, and entering the power save state after receipt of the power save response from the second NAN device.

Example 40 includes the subject matter of Example 38, and optionally, comprising processing the power save request from the second NAN device, and transmitting the power save response to the second NAN device.

Example 41 includes the subject matter of Example 40, and optionally, comprising entering the power save state after transmission of the power save response from the first NAN device.

Example 42 includes the subject matter of Example 40, and optionally, comprising entering the power save state after reception of an acknowledge frame from the second NAN device, the acknowledge frame to acknowledge reception of the power save response by the second NAN device.

Example 43 includes the subject matter of any one of Examples 38-42, and optionally, comprising allowing the first NAN device to remain in the power save state until an end of the CRB.

Example 44 includes the subject matter of any one of Examples 38-43, and optionally, comprising allowing the first NAN device to remain in the power save state for a power save period having a preconfigured duration within the CRB.

Example 45 includes the subject matter of Example 44, and optionally, comprising waking up the first NAN device at an end of the power save period.

Example 46 includes the subject matter of Example 44 or 45, and optionally, wherein the preconfigured duration is shorter than a duration of the CRB.

Example 47 includes the subject matter of any one of Examples 38-46, and optionally, comprising allowing the first NAN device to remain in the power save state for a power save period having a duration indicated in at least one of the power save request or the power save response.

Example 48 includes the subject matter of any one of Examples 38-47, and optionally, comprising communicating a cancel message to cancel the power save request during the CRB.

Example 49 includes the subject matter of any one of Examples 38-48, and optionally, wherein the power save request comprises a More Data subfield in a frame control field, the More Data subfield comprises a value to indicate no more traffic to transmit.

Example 50 includes the subject matter of any one of Examples 38-48, and optionally, wherein the power save request comprises an End Of Service Period (EOSP) subfield in a QoS control field, the EOSP subfield comprises a value to indicate an end of a service period.

Example 51 includes the subject matter of any one of Examples 38-50, and optionally, wherein the power save response comprises a Power Management subfield in a frame control field, the Power Management subfield comprises a value to indicate a power save state.

Example 52 includes the subject matter of any one of Examples 38-51, and optionally, wherein the NDL comprises a Synchronized NDL (S-NDL).

Example 53 includes the subject matter of any one of Examples 38-51, and optionally, wherein the NDL comprises a Paging NDL (P-NDL).

Example 54 includes the subject matter of any one of Examples 38-53, and optionally, wherein the CRB comprises one or more contiguous time slots corresponding to a same wireless communication channel to communicate data of the NDL between the first and second NAN devices.

Example 55 includes a product including one or more tangible computer-readable non-transitory storage media comprising computer-executable instructions operable to, when executed by at least one computer processor, enable the at least one computer processor to cause a first Neighbor Awareness Networking (NAN) device to setup a NAN Data Link (NDL) with a second NAN device; communicate a power save request between the first and second NAN devices during a Common Resource Block (CRB) of the NDL; communicate a power save response between the first and second NAN devices, the power save response in response to the power save request; and enter a power save state for at least part of the CRB.

Example 56 includes the subject matter of Example 55, and optionally, wherein the instructions, when executed, cause the first NAN device to transmit the power save request to the second NAN device, and to enter the power save state after receipt of the power save response from the second NAN device.

Example 57 includes the subject matter of Example 55, and optionally, wherein the instructions, when executed, cause the first NAN device to process the power save request from the second NAN device, and to transmit the power save response to the second NAN device.

Example 58 includes the subject matter of Example 57, and optionally, wherein the instructions, when executed, cause the first NAN device to enter the power save state after transmission of the power save response from the first NAN device.

Example 59 includes the subject matter of Example 57, and optionally, wherein the instructions, when executed, cause the first NAN device to enter the power save state after reception of an acknowledge frame from the second NAN device, the acknowledge frame to acknowledge reception of the power save response by the second NAN device.

Example 60 includes the subject matter of any one of Examples 55-59, and optionally, wherein the instructions, when executed, allow the first NAN device to remain in the power save state until an end of the CRB.

Example 61 includes the subject matter of any one of Examples 55-60, and optionally, wherein the instructions, when executed, allow the first NAN device to remain in the power save state for a power save period having a preconfigured duration within the CRB.

Example 62 includes the subject matter of Example 61, and optionally, wherein the instructions, when executed, wake up the first NAN device at an end of the power save period.

Example 63 includes the subject matter of Example 61 or 62, and optionally, wherein the preconfigured duration is shorter than a duration of the CRB.

Example 64 includes the subject matter of any one of Examples 55-63, and optionally, wherein the instructions, when executed, allow the first NAN device to remain in the power save state for a power save period having a duration indicated in at least one of the power save request or the power save response.

Example 65 includes the subject matter of any one of Examples 55-64, and optionally, wherein the instructions, when executed, cause the first NAN device to communicate a cancel message to cancel the power save request during the CRB.

Example 66 includes the subject matter of any one of Examples 55-65, and optionally, wherein the power save request comprises a More Data subfield in a frame control field, the More Data subfield comprises a value to indicate no more traffic to transmit.

Example 67 includes the subject matter of any one of Examples 55-65, and optionally, wherein the power save request comprises an End Of Service Period (EOSP) subfield in a QoS control field, the EOSP subfield comprises a value to indicate an end of a service period.

Example 68 includes the subject matter of any one of Examples 55-67, and optionally, wherein the power save response comprises a Power Management subfield in a frame control field, the Power Management subfield comprises a value to indicate a power save state.

Example 69 includes the subject matter of any one of Examples 55-68, and optionally, wherein the NDL comprises a Synchronized NDL (S-NDL).

Example 70 includes the subject matter of any one of Examples 55-68, and optionally, wherein the NDL comprises a Paging NDL (P-NDL).

Example 71 includes the subject matter of any one of Examples 55-70, and optionally, wherein the CRB comprises one or more contiguous time slots corresponding to a same wireless communication channel to communicate data of the NDL between the first and second NAN devices.

Example 72 includes an apparatus of wireless communication by a first NAN device, the apparatus comprising means for setting up a NAN Data Link (NDL) with a second NAN device; means for communicating a power save request between the first and second NAN devices during a Common Resource Block (CRB) of the NDL; means for communicating a power save response between the first and second NAN devices, the power save response in response to the power save request; and means for entering a power save state for at least part of the CRB.

Example 73 includes the subject matter of Example 72, and optionally, comprising means for transmitting the power save request to the second NAN device, and entering the power save state after receipt of the power save response from the second NAN device.

Example 74 includes the subject matter of Example 72, and optionally, comprising means for processing the power save request from the second NAN device, and transmitting the power save response to the second NAN device.

Example 75 includes the subject matter of Example 74, and optionally, comprising means for entering the power save state after transmission of the power save response from the first NAN device.

Example 76 includes the subject matter of Example 74, and optionally, comprising means for entering the power save state after reception of an acknowledge frame from the second NAN device, the acknowledge frame to acknowledge reception of the power save response by the second NAN device.

Example 77 includes the subject matter of any one of Examples 72-76, and optionally, comprising means for allowing the first NAN device to remain in the power save state until an end of the CRB.

Example 78 includes the subject matter of any one of Examples 72-77, and optionally, comprising means for allowing the first NAN device to remain in the power save state for a power save period having a preconfigured duration within the CRB.

Example 79 includes the subject matter of Example 78, and optionally, comprising means for waking up the first NAN device at an end of the power save period.

Example 80 includes the subject matter of Example 78 or 79, and optionally, wherein the preconfigured duration is shorter than a duration of the CRB.

Example 81 includes the subject matter of any one of Examples 72-80, and optionally, comprising means for allowing the first NAN device to remain in the power save state for a power save period having a duration indicated in at least one of the power save request or the power save response.

Example 82 includes the subject matter of any one of Examples 72-81, and optionally, comprising means for communicating a cancel message to cancel the power save request during the CRB.

Example 83 includes the subject matter of any one of Examples 72-82, and optionally, wherein the power save request comprises a More Data subfield in a frame control field, the More Data subfield comprises a value to indicate no more traffic to transmit.

Example 84 includes the subject matter of any one of Examples 72-82, and optionally, wherein the power save request comprises an End Of Service Period (EOSP) subfield in a QoS control field, the EOSP subfield comprises a value to indicate an end of a service period.

Example 85 includes the subject matter of any one of Examples 72-84, and optionally, wherein the power save response comprises a Power Management subfield in a frame control field, the Power Management subfield comprises a value to indicate a power save state.

Example 86 includes the subject matter of any one of Examples 72-85, and optionally, wherein the NDL comprises a Synchronized NDL (S-NDL).

Example 87 includes the subject matter of any one of Examples 72-85, and optionally, wherein the NDL comprises a Paging NDL (P-NDL).

Example 88 includes the subject matter of any one of Examples 72-87, and optionally, wherein the CRB comprises one or more contiguous time slots corresponding to a same wireless communication channel to communicate data of the NDL between the first and second NAN devices.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a first Neighbor Awareness Networking (NAN) device to:
setup a NAN Data Link (NDL) with a second NAN device;
communicate a power save request between the first and second NAN devices during a Common Resource Block (CRB) of the NDL;
communicate a power save response between the first and second NAN devices, the power save response in response to the power save request; and
enter a power save state for at least part of the CRB.

2. The apparatus of claim 1 configured to cause the first NAN device to transmit the power save request to the second NAN device, and to enter the power save state after receipt of the power save response from the second NAN device.

3. The apparatus of claim 1 configured to cause the first NAN device to process the power save request from the second NAN device, and to transmit the power save response to the second NAN device.

4. The apparatus of claim 3 configured to cause the first NAN device to enter the power save state after transmission of the power save response from the first NAN device.

5. The apparatus of claim 3 configured to cause the first NAN device to enter the power save state after reception of an acknowledge frame from the second NAN device, the acknowledge frame to acknowledge reception of the power save response by the second NAN device.

6. The apparatus of claim 1 configured to allow the first NAN device to remain in the power save state until an end of the CRB.

7. The apparatus of claim 1 configured to allow the first NAN device to remain in the power save state for a power save period having a preconfigured duration within the CRB.

8. The apparatus of claim 7 configured to wake up the first NAN device at an end of said power save period.

9. The apparatus of claim 7, wherein said preconfigured duration is shorter than a duration of said CRB.

10. The apparatus of claim 1 configured to allow the first NAN device to remain in the power save state for a power save period having a duration indicated in at least one of the power save request or the power save response.

11. The apparatus of claim 1 configured to cause the first NAN device to communicate a cancel message to cancel the power save request during the CRB.

12. The apparatus of claim 1, wherein the power save request comprises a More Data subfield in a frame control field, the More Data subfield comprises a value to indicate no more traffic to transmit.

13. The apparatus of claim 1, wherein the power save request comprises an End Of Service Period (EOSP) subfield in a QoS control field, the EOSP subfield comprises a value to indicate an end of a service period.

14. The apparatus of claim 1, wherein the power save response comprises a Power Management subfield in a frame control field, the Power Management subfield comprises a value to indicate a power save state.

15. The apparatus of claim 1, wherein the NDL comprises a Synchronized NDL (S-NDL).

16. The apparatus of claim 1, wherein the NDL comprises a Paging NDL (P-NDL).

17. The apparatus of claim 1, wherein the CRB comprises one or more contiguous time slots corresponding to a same wireless communication channel to communicate data of the NDL between the first and second NAN devices.

18. The apparatus of claim 1 comprising a radio to communicate said power save request and said power save response.

19. The apparatus of claim 1 comprising one or more antennas, a processor, and a memory.

20. A product including one or more tangible computer-readable non-transitory storage media comprising computer-executable instructions operable to, when executed by at least one computer processor, enable the at least one computer processor to cause a first Neighbor Awareness Networking (NAN) device to:
setup a NAN Data Link (NDL) with a second NAN device;
communicate a power save request between the first and second NAN devices during a Common Resource Block (CRB) of the NDL;
communicate a power save response between the first and second NAN devices, the power save response in response to the power save request; and
enter a power save state for at least part of the CRB.

21. The product of claim 20, wherein the instructions, when executed, cause the first NAN device to transmit the power save request to the second NAN device, and to enter the power save state after receipt of the power save response from the second NAN device.

22. The product of claim 20, wherein the instructions, when executed, cause the first NAN device to process the power save request from the second NAN device, and to transmit the power save response to the second NAN device.

23. The product of claim 20, wherein the CRB comprises one or more contiguous time slots corresponding to a same wireless communication channel to communicate data of the NDL between the first and second NAN devices.

24. A first Neighbor Awareness Networking (NAN) device comprising:
one or more antennas;
a radio;
a memory;
a processor; and
a controller configured to cause the first NAN device to:
setup a NAN Data Link (NDL) with a second NAN device;
communicate a power save request between the first and second NAN devices during a Common Resource Block (CRB) of the NDL;
communicate a power save response between the first and second NAN devices, the power save response in response to the power save request; and
enter a power save state for at least part of the CRB.

25. The first NAN device of claim 24, wherein the CRB comprises one or more contiguous time slots corresponding to a same wireless communication channel to communicate data of the NDL between the first and second NAN devices.
